(19) United States
(12) Patent Application Publication
(10) Pub. No.: US 2015/0197434 A1
(43) Pub. Date: Jul. 16, 2015

(54) Use Of Celluloses In Water Treatment

(71) Applicant: Buckman Laboratories International, Inc., Memphis, TN (US)

(72) Inventors: Yong Zou, Chesterfield, MO (US); Philip M. Hoekstra, Cordova, TN (US)

(21) Appl. No.: 14/591,939

(22) Filed: Jan. 8, 2015

Related U.S. Application Data
(60) Provisional application No. 61/926,984, filed on Jan. 14, 2014.

(51) Int. Cl. C02F 1/52

(52) U.S. Cl. CPC C02F 1/5263

(57) ABSTRACT

Methods to improve water treatment for industrial uses are described. One method involves admixing source water, such as from a river or other flowing source or body of water, with a modified cellulose and a coagulant and/or flocculant to provide a treated water with the modified cellulose present in an effective amount to improve water treatment efficiency, such as in allowing use of reduced amounts of coagulant and/or flocculant, and/or reduced suspended solids, turbidity, and/or color clarification.

This application claims the benefit under 35 U.S.C. §119(e) of prior U.S. Provisional Patent Application No. 61/926,984, filed Jan. 14, 2014, which is incorporated in its entirety by reference herein.

### BACKGROUND OF THE INVENTION

The present invention relates to processes for treating waters, and particularly relates to using cellulose in water treatments, and more particularly relates to using combinations of cellulose and coagulants/flocculants in water treatments.

Pulp and paper manufacturers use large volumes of water in the wet-end production process, with river or lake water or other non-treated water being principal sources. This “influent” water almost always requires treatment to remove suspended particles prior to use in production to decrease microbiological growth, prevent product contamination, and decrease corrosion and clogging of equipment. Typical water treatments involve the use of inorganic metal-based materials, such as aluminum sulfate or other aluminum salts, ferric chloride, and low molecular weight cationic polymers. These chemicals can leave residues of metals and salts (sulfates and chlorides) and modify the pH of the treated water.

The present inventors have recognized the need for improved water treatment methods which can reduce or avoid the indicated previous problems, allow use of poorer water quality intake sources for industrial and municipal uses and other applications, and/or provide other advantages.

### SUMMARY OF THE INVENTION

A feature of the present invention is to provide methods to improve water treatment on raw or lower quality influent water to be used in industrial or municipal applications, and the like.

Additional features and advantages of the present invention will be set forth in part in the description which follows, and in part will be apparent from the description, or may be learned by practice of the present invention. The objectives and other advantages of the present invention will be realized and obtained by means of the elements and combinations particularly pointed out in the written description and appended claims.

To achieve these and other advantages and in accordance with the purposes of the present invention, as embodied and broadly described herein, the present invention relates to a method for treating water, comprising a) mixing source water, cellulose, and at least one of a coagulant and flocculant, to provide treated water, wherein the treated water contains suspended solids. The cellulose includes microfibrillated cellulose (MFC), nanofibrillated cellulose (NFC), microcrystalline cellulose (MCC), and/or ultrafine cellulose (UFC), or any combination thereof. The method further includes b) at least partially separating the solids from the treated water.

The present invention further relates to a method for treating water, comprising a) mixing source water and cellulose to provide a first treated water, wherein the first treated water contains suspended solids and the cellulose includes microfibrillated cellulose, nanofibrillated cellulose, microcrystalline cellulose, and/or ultrafine cellulose, or any combination thereof; b) mixing the first treated water with coagulant to provide a coagulated treated water; c) mixing the coagulated treated water with flocculant to provide a flocculated treated water; and d) at least partially separating the suspended solids from the flocculated treated water.

It is to be understood that both the foregoing general description and the following detailed description are exemplary and explanatory only and are only intended to provide a further explanation of the present invention, as claimed.

The accompanying drawings, which are incorporated in and constitute a part of this application, illustrate some of the features of the present invention and together with the description, serve to explain the principles of the present invention.

### BRIEF DESCRIPTION OF THE DRAWINGS

FIG. 1 illustrates a general process flow diagram for treating water with a modified cellulose, and coagulant and flocculant, according to an embodiment of the present invention.

FIG. 2 is a graph which shows the effect on turbidity (NTU) of modified cellulose on the treatment of Mississippi river water with coagulant and flocculant at different dosage levels thereof, according to an example of the present invention.

FIG. 3 is a graph which shows the effect on color of modified cellulose on the treatment of Mississippi river water with coagulant and flocculant at different dosage levels thereof, according to an example of the present invention.

FIG. 4 is a graph which shows the effect on turbidity (NTU) of modified cellulose on the treatment of Mississippi river water with a higher dosage of coagulant, and flocculant at different dosage levels, according to an example of the present invention.

FIG. 5 is a graph which shows the effect on color of modified cellulose on the treatment of Mississippi river water with a higher dosage of coagulant, and flocculant at different dosage levels, according to an example of the present invention.

### DETAILED DESCRIPTION OF THE PRESENT INVENTION

The methods of the present invention include the use of modified cellulose as part of a water treatment. The modified cellulose can be used in conjunction with a coagulant(s) and/or flocculant(s) to improve efficiency of the water treatment. The water to be treated can be raw or natural sources of water, or other untreated or non-fully treated sources of water, which have suspended solids, turbidity, and/or discoloration, or other treatment needs. In the present invention, the modified cellulose can be used in conjunction with coagulants and/or flocculants to improve water treatment of raw water to be used as industrial or municipal influent or source water. The modified cellulose can modify the performance of the water treatment and/or water product quality as compared to the treatment without the modified cellulose. Use of the modified cellulose material in water treatments can allow for reductions in dosages needed for co-additives, such as coagulants and/or flocculants, and improved water clarification, as compared to water treatments without the cellulose. The use of the modified cellulose in water treatments can provide increased removal of suspended solids, reduced discoloration, and/or reduced turbidity of source water to be used in industrial water or municipal water applications, or others.

The modified cellulose can be one or types of nanocellulose (microfibrillated cellulose (MFC), nanofibrillated cellulose (NFC), and/or microcrystalline cellulose (MCC)), ultrafine cellulose (UFC), or any combinations thereof. The modified cellulose can be added to raw or source water in dry particulate form, in a dispersed liquid form, or in any combinations thereof. The modified cellulose can be the only type of cellulose added for a water treatment or it can be added in combination with other types of cellulose. The modified cellulose can be a green material, which means safer applications, and it is renewable and biodegradable, and it is a stable product, without any harmful by-product, environmental issues during manufacturing or application.

Examples of the modified cellulose, such as MFC, NFC, MCC, and UFC, are shown in Table 1. Other structures and dimensional ranges may be used within the categories.

TABLE 1

| | MFC | NFC | MCC | UFC |
|---|---|---|---|---|
| Structure | fibrils, or fibril | fibrils, or fibril | microcrystallites | particles, or |
| | bundles, or | bundles, or | (microrods), or | others. |
| | others. | others. | others. | |
| Length (L) | ≧1000 nm (1 | <1000 nm, or | ≧1000 nm (1 | — |
| | μm), or 1 μm- | 1 nm-999 nm, | μm), or 1 μm- | |
| | 1000 μm (1 mm), | or 1 nm-900 | 1000 μm (1 mm), | |
| | or >1 μm, or 3 | nm, or 50 nm- | or >1 μm, or 5 | |
| | μm-900 μm, or | 500 nm, or 100 | μm-900 μm, or | |
| | 2 μm-500 μm | nm-200 nm, or | 2 μm-500 μm, | |
| | or others. | others. | or 10 μm-750 | |
| | | | μm or others. | |
| Diameter (D) | <100 nm, or | <100 nm, or | <1000 nm, or | 1 μm-25 μm, or |
| | 1 nm-20 nm, or | 1 nm-20 nm, or | 1 nm-1000 nm, | 5 μm-15 μm, or |
| | 1 nm-10 nm, or | 1 nm-10 nm, or | or 1 nm-500 | 6 μm-10 μm, |
| | 3 nm-nm, or | 3 nm-5 nm, or | nm, or 1 nm- | or about 8 μm, or |
| | others. | others. | 100 nm, or | others. |
| | | | others. | |
| Aspect ratio | ≧10/1, or ≧50/1, | ≧5/1, or ≧10/1, or | ≧5/1, or ≧10/1, | — |
| (AR), L/D | or ≧100/1, or | ≧50/1, or ≧100/1, | ≧50/1, or ≧100/1, | |
| | ≧1000/1, 10/1- | or ≧1000/1, 5/1- | or ≧1000/1, or | |
| | 1000/1, or others. | 1000/1, or others. | 5/1-1000/1, or | |
| | | | others. | |

As indicated, the modified cellulose can be used in conjunction with coagulants and/or flocculant, or other additives. Use of the modified cellulose in such methods can allow for decreased coagulant and/or flocculant dosage requirements as compared to water treatment without the cellulose to achieve a specific treatment efficiency level, such as with respect to removal of suspended solids, color, and/or turbidity. For instance, the modified cellulose can be used as an additive to be used with polymer coagulants for water treatment, wherein the coagulants' efficiency can be improved (e.g., lower coagulant dosage, lower turbidity, lower color value).

Treatment of a raw or natural water source, such as water drawn from flowing water or bodies of water, with a treatment method of the present invention can give a better quality water product. The water to be treated can be river water, stream water, lake water, pond water, reservoir water, well water, spring water, runoff water, cistern water, desalinated seawater, and the like, or any combinations thereof. This better quality can be obtained in terms of improved clarity, reduced color, and/or more efficient removal of suspended solids from raw water, and/or other improvements, or any combinations of these improvements. These improvements can allow use of poorer water sources as intake or influent water to be treated before use in industrial and municipal uses and other applications. The treatment can be expanded to reuse of waste water, within a facility or of waste water by other subsequent users.

The water product of treatment methods of the present invention may be used directly, such as for industrial process water, or in municipal water uses not requiring chlorination, or other uses. The water product of treatment methods of the present invention may be further treated, such as by chlorination or other water treatment methods, such as to provide a drinking water or other grades or types of treated water.

As indicated, the combined use of modified cellulose(s) with coagulant(s) and/or flocculant(s) can enhance clarification (e.g., reduce suspended solids, color, and/or turbidity) of the water. As an example, the step of promoting the formation of flocs is performed by adding one or more coagulants and/or flocculants to the water. If both are used, preferably the coagulant and flocculant are added sequentially. If a coagulant and flocculant is used at a coagulation/flocculation reactor, the coagulant usually is added first in a first stage of processing, followed by addition of flocculant in a second stage of processing. Suitable coagulants and/or flocculants for treatment of water are indicated infra and can include those generally known in the art, and may be selected based, for example, on the particular water source materials being processed. Preferably, the modified cellulose can be added before treatment of the water with coagulant and/or flocculant. The modified cellulose can impart enhanced treatment efficacy when added before coagulation/flocculation.

Using the water treatment methods of the present invention, turbidity can be decreased at least 10%, or at least 15%, or at least 25%, in the treated water after the separating as compared to treated water without the modified cellulose. Color can be decreased at least 5%, or at least 10%, or at least 25%, in the treated water after the separating as compared to treated water without the modified cellulose. A dosage of coagulant used on the water which is treated with the modified cellulose can be reduced by at least 40%, or at least 60%, or at least 80%, compared to a dosage used on water that is unmodified with the modified cellulose and treated with the coagulant and flocculant, and provide at least the same weight percentage of solids removal from the water. Similar reductions can be provided in the dosage of flocculant.

The expression “cellulose” can refer to any types of cellulose, such as cellulose fibers (cellulose material), which contain modified cellulose at least in part. As indicated, the modified cellulose improves (reduces) the amount of suspended solids, turbidity, and/or color of water or other water properties as compared to the water without the modified cellulose. Preferably, the modified cellulose is nanocelluloses, ultrafine celluloses, or combinations of both types. Nanocelluloses can refer to microfibrillated cellulose (MFC), nanofibrillated cellulose (NFC), microcrystalline cellulose (MCC), or any combinations thereof. The nanocelluloses can be a charged material, such as anionic. The nanocelluloses can have high aspect ratio, high surface area, high adsorption capacity, and useful mechanical properties, and they are renewable, biodegradable green materials.

Microfibrillated cellulose (MFC) can refer to cellulose comprising microfibrils, e.g., a set of isolated cellulose microfibrils or microfibril bundles derived from cellulose raw material which, for purposes of this invention, are differentiated from nanocelluloses at least based on fibril length dimension. Cellulose fibers contain microfibrils that are filamentous constituents of cellulose fibers. A cellulose fiber is made fibrous by fibrillating. The aspect ratio (length/diameter) of microfibrils is typically high; the length of individual microfibrils can be more than one micrometer (μm) and the diameter (e.g., number average) can be less than one micrometer and typically less than 100 nm, such as less than 20 nm. The dimensions and structures of microfibrils or microfibril bundles depend on the raw material and the manufacturing method. As indicated, microfibrillated celluloses can be very thin in diameter, such as less than 100 nm, or other values, and have a length of at least 1 μm for purposes of how the terminology is used herein. The microfibrillated cellulose materials can be comprised of microsize-class fibrils having a diameter of from about 1 nm to about 10 nm, and a length within the μm class (≧1 μm and ≦1 mm), such as from about 1 μm to 500 μm, or other dimensions. The diameter and length values indicated herein can be average values for a number of fibrils in the category, or absolute values that apply to all fibrils in the category.

Microfibrillated fibers can be made using known methods. Microfibrillated cellulose may be formed from any botanical raw material, e.g. wood-based raw material, such as hardwood raw material or softwood raw material, or other botanical raw material that contains cellulose. Botanical raw materials may include e.g. agricultural waste, grasses, straw, bark, caryopses, peels, flowers, vegetables, cotton, maize, wheat, oat, rye, barley, rice, flax, hemp, abaca, sisal, kenaf, jute, ramie, bagasse, bamboo or reed or different combinations thereof.

Microfibrillated cellulose may also contain hemicellulose, lignin and/or extractive agents, the amount of which depends on the employed raw material. Microfibrillated cellulose is isolated from the above-described raw material containing cellulose with an apparatus suitable for the purpose, e.g. a grinder, comminutor, homogenizer, fluidizer, micro- or macrofluidizer, cryo crushing and/or ultrasonic disintegrator. Microfibrillated cellulose may also be obtained directly by a fermentation process using microorganisms. Microfibrillated cellulose may be any chemically or physically modified derivative of cellulose having microfibrils or microfibril bundles. Chemical modification may be based e.g. on a carboxy-methylation, oxidation, esterification and etherification reaction of cellulose molecules. The modification may also be carried out by physical adsorption of anionic, cationic or non-ionic materials or combinations thereof to the surface of cellulose. The modification may be performed before, during, or after the manufacture of microfibrillated cellulose. Microfibrillated cellulose may be formed by any manner known per se in the art from cellulose-based raw material. As an example, a mixture composition containing microfibrillated cellulose can be formed from dried and/or concentrated cellulose raw material by fibrillating. The cellulose raw material can be concentrated. The cellulose raw material can be dried. The cellulose raw material can be dried and concentrated. The cellulose raw material can be chemically preprocessed to disintegrate more easily, i.e. labilized, whereby the mixture composition containing microfibrillated cellulose is formed from chemically labilized cellulose raw material. For example, a N-oxyl (e.g. 2,2,6,6-tetramethyl-1-piperidine N-oxide) mediated oxidation reaction provides very labile cellulose raw material which is exceptionally easy to disintegrate into microfibrillated cellulose. This type of chemical pre-processing is described for example in WO 09/084566, which is incorporated in its entirety herein.

Nanofibrillated cellulose (NFC) can be a material comprised of nanosized cellulose fibrils with a high aspect ratio (length to width ratio). As indicated, NFC is differentiated from MFC for purposes of this invention primarily based on the fibril lengths. The nanofibrillated cellulose material can be comprised of nanosize-class fibrils, the diameter of which can be less than 100 nm, and the length within the nm class (≦1000 nm). The nanofibrillated cellulose material preferably can have nanosize scale dimensions of from about 1 to about 20 nm wide (diameter), or other values, and from about 50 nm to about 500 nm long, or other dimensions, such as 3-5 nm wide and 100-200 nm in length, or other dimensions. A preferred nanofibrillated fibril may be about 100-200 nm in length and about 3-5 nm wide, or other dimensions, and comprise a small bundle of the cellulose strands tightly bound together. The nanocellulose source materials and methods used to produce nanofibrillated cellulose can overlap with those indicated for producing microfibrillated cellulose. These approaches generally can include chemical delignification, mechanical diminution, chemical diminution, fermentation, and dissolution or different combinations of them, or other approaches. Nanofibrillated celluloses may be commercially obtained, such as a NFC suspension ARBOCEL® MF40-10 from J. Rettenmaier & Sohne GMBH Co., Germany, or other sources.

Microcrystalline cellulose (MCC) is purified, partially depolymerized cellulose. MCC preferably can have particle sizes in the micrometer-class of from 1 μm up to about 1000 μm, such as from about 5 μm to about 900 μm, or from about 10 μm to about 750 μm, or other values. MCC can be obtained and used in different grades. Powder grade MCC can be obtained from highly purified pulp by depolymerization of the pulp to provide cellulose microcrystallites (microrods), which can be dried to form powder grade MCC. Colloidal grade MCC can be produced by mixing the cellulose microcrystallites with carboxymethylcellulose sodium and drying the mixture. MCC may be commercially obtained, such as the CEOLUS™ MCC products from Asahi Kasei, Japan.

Ultrafine cellulose (UFC) is a cellulose-derived product which can have a small particle size with a major dimension (diameter) of about 5-15 μm, such as about 8 μm, or other values. UFC can be made from renewable material. Ultrafine cellulose may be commercially obtained, such as ARBOCELL® UFC-100 from JRS Inc., USA. Ultrafine cellulose is shown in WO 2006/034837, which is incorporated in its entirety herein.

The modified cellulose, such as MFC, NFC, MCC, and/or UFC, may be obtained and used in dry particulate form or as suspended or otherwise dispersed in a carrier fluid. Modified cellulose can be used in methods and water treatments of the present application as a combination of two or more of MFC, NFC, MCC, and/or UFC, and in any mixing proportions. A mixture of MFC and NFC may be used wherein the modified cellulose comprises fibrils having nanometer-sized diameters (<1000 nm) and a portion of the fibrils have lengths in the nanometer range (<1000 nm) and another portion has lengths in micrometer range (≧1000 nm). Other combinations of the various nanocelluloses and/or UFC may be used.

Other nanocelluloses may be used, such as nanocrystalline cellulose (NCC) or others. NCC is a more crystalline form of nanocellulose. NCC is generally referred to as cellulose nanowhiskers. Nanocrystalline cellulose (NCC) can be extracted from lignocellulosics by acidic hydrolysis extraction methods resulting in the formation of nanodimensional cellulose crystallites with a very high surface to volume ratios. The NCC can be in the form of highly crystalline and rigid nanoparticles. The NCC may be commercially obtained as NCC-FP, from FP Innovations in Quebec, Canada, and NCC-Alb, from Alberta Innovates in Alberta, Canada.

A portion of the cellulose used may be a type of cellulose that is not modified cellulose. The different types of cellulose may be carboxymethylated cellulose, synthetic polymer fibers, fibers made from dissolving pulp, or other forms of cellulose. The cellulose may be present in the form of pulp, which may be chemical pulp, mechanical pulp, thermomechanical pulp or chemi (thermo) mechanical pulp or a kraft pulp. The pulp may be pulp from hardwood, softwood, or both types, or may comprise textile fibers, agricultural plant pulp, and the like. The cellulose may be bleached or unbleached.

The cellulose added for water treatment can contain a total amount of the modified cellulose of at least about 5 wt %, at least 10 wt %, or at least 20 wt %, or at least 30 wt %, or at least 40 wt %, or at least 50 wt %, or least 60 wt %, or at least 70 wt %, or at least 80 wt %, or at least 90 wt %, or at least 95 wt %, or at least 99 wt %, or from about 5 wt % to 100 wt %, or from about 10 wt % to about 99 wt %, or from about 20 wt % to about 95 wt %, or from about 50 wt % to 100 wt %, or from about 80 wt % to 100 wt %, or from about 90% to 100 wt %, or other amounts, based on the total amount of cellulose used or to be used as a treatment additive for water.

As indicated, in treating water, the modified cellulose can be added by itself as a dry particulate, or as dispersed in a fluid carrier, such as a suspension, slurry, gel, or pulp, or other forms. The carrier can be aqueous (water), an organic solvent, or mixtures of different organics solvents and/or water. An organic solvent may be an alcohol, such as isopropanol, ethanol, glycol, polyethylene glycol, acetone, and the like, or any combinations thereof. The modified cellulose can be dispersed in dilute or concentrated forms in a liquid. The amounts of modified cellulose in a carrier liquid may be from about 0.1 wt % to about 99 wt %, or from about 5 wt % to about 90 wt %, or from about 25 wt % to about 75 wt %, or other amounts, based on the solids content of the modified cellulose and the total weight of the fluid and all additives. As indicated, other types of cellulose, such as longer non-fibrillated cellulose fibers, may be included. Preferably, the modified cellulose comprises the predominant amount (by weight) of cellulose used with respect to other types of cellulose, such as in the above-indicated percentages. The temperature of any fluid used to disperse the modified cellulose preferably is kept between the freezing and boiling points of the fluid, and may be room or ambient temperature or other temperatures.

Although the effective amount of modified cellulose may vary, depending on the water composition and conditions, the modified cellulose can be added in an amount of from about 1 ppm to about 100 ppm or more, or from about 2 ppm to about 40 ppm, or from about 3 ppm to about 50 ppm, or from about 5 ppm to about 100 ppm, or other amounts, all on a solids weight basis.

The modified cellulose may be used alone or in combination with other additives. As indicated, the combined use of modified cellulose with coagulant and/or flocculant can enhance water treatment performance and results. Their combined use can comprise their sequential additions or simultaneous addition. The modified cellulose may be introduced into raw water at a single point or in multiple points, in a continuous or non-continuous manner. It may, for example, be introduced into a flowing water stream, or batch or semi-batch water held in a tank or vessel, using a metering pump (e.g., if in fluid-dispersed form), or it may be gravity fed (e.g., if in dry particulate form). When referring herein to modified cellulose addition, the addition can entail addition of the modified cellulose separately into the process apparatus, or in combination with another feedstream fed to the same apparatus, or both. The addition of the modified cellulose to water for treatment preferably is accompanied by stirring or agitation to disperse the modified cellulose throughout the water in a substantially uniform or uniform manner. For water held in a vessel or tank, an agitator mechanism such as a mixer with an impeller mechanism or other mixing mechanism may be used, which can be conventional types. For addition of the modified cellulose to a flowing stream, an in-line mixer may be used, or may not be needed if the fluid stream is in sufficiently turbulent flow conditions to cause mixing of the added modified cellulose and the flowing water.

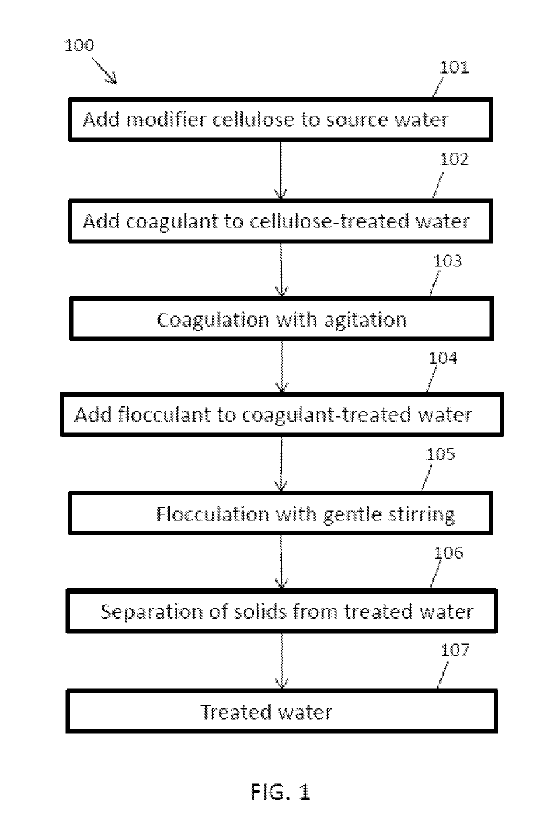

FIG. 1 illustrates a general process, indicated by the process flow chart 100, for treating water with modified cellulose, and then sequentially with coagulant and flocculant according a method of the present invention. The process is shown with process steps 101-107 in FIG. 1. Additional steps may be included and/or certain steps may be omitted (such as the flocculation step), depending on the particular process, preferably with the modified cellulose addition and at least one of coagulation and/or flocculation always included in the process.

As referenced herein, coagulation can involve the destabilization of colloids by neutralizing the forces that keep them apart. For instance, cationic coagulants provide positive electric charges to reduce the negative charge (zeta potential) of the colloids. As a result, the particles can collide to form larger particles (flocs). Rapid mixing typically is required to disperse the coagulant throughout the liquid. Care must be taken not to overdose the coagulants as this can cause a complete charge reversal and restabilize the colloid complex. The flocs may not be visible to the naked eye (e.g., microflocs). Flocculation can be the action of polymers to form bridges between the flocs, and bind the particles into large agglomerates or clumps. Flocculation can increase the particle size of the floc to form visible suspended particles. Bridging can occur when segments of the polymer chain adsorb on different particles and help particles aggregate. For instance, an anionic flocculant can react against a positively charged suspension, adsorbing on the particles and causing destabilization either by bridging or charge neutralization. In flocculation, the flocculating agent should be added by slow and gentle mixing to allow for contact between the small flocs and to agglomerate them into larger particles. The newly formed agglomerated particles are quite fragile and can be broken apart by shear forces during mixing. Care must also be taken to not overdose the polymer as doing so can cause settling/clarification problems. For instance, anionic polymers themselves are lighter than water. As a result, increasing their dosage can increase the tendency of the floc to float and not settle. Once suspended particles are flocculated into larger particles, they can usually be removed from the liquid by sedimentation, provided that a sufficient density difference exists between the suspended matter and the liquid. Such particles can also be removed or separated by media filtration, straining or floatation. When a filtering process is used, the addition of a flocculant may not be required since the particles formed by the coagulation reaction may be of sufficient size to allow removal. The flocculation reaction not only can increase the size of the floc particles to settle them faster, but also can affect the physical nature of the floc, making these particles less gelatinous and thereby easier to dewater.

The coagulant can be a tannin-based ammonium salt, ferric sulfate, ferric chloride, aluminum sulfate (alum), polyaluminum chloride (PAC), sodium aluminate, polyferric sulfate, aluminum chlorohydrate, polyaluminum silicate chloride, epichlorohydrin dimethylamine copolymer (epi-DMA), diallyldimethylammonium chloride (DADMAC), polyamines, melamine formaldehyde resin, polyethylenimine, or any combination thereof. The coagulant can be obtained from a commercial source, such as BUBOND® 408, BUBOND® 505, and BUBOND® 5828, from Buckman International Laboratories, Memphis Tenn., USA. The coagulant can be added to water in an amount of from about 10 to about 1000 ppm, or from about 25 to about 750 ppm, or from about 50 to about 500 ppm, or from about 75 to about 300 ppm, or from about 100 to about 200 ppm, or other amounts, on a solids weight basis.

The flocculant can be a polyacrylamide polymer, polyethyleneimine, polyamide-amine, polyamine, polyethylene oxide, sulfonated compound, starch derivative, polysaccharide, alginate, activated silica, colloidal clay, alum, ferric hydroxide, and the like, or any combination thereof. The flocculant can be obtained from a commercial source, such as BUFLOC® 5904, and BUFLOC® 5532, from Buckman International Laboratories. The polyacrylamide can be a high molecular weight ionically charged polyacrylamide. The flocculant can carry active groups with a charge which can counterbalance charge of the particles. Waters which contain a high proportion of colloidal organic substances may not be suitable for direct flocculation, and can be coagulated to destabilize the water before flocculation treatment. The flocculant can be added to water in an amount of from about 10 to about 1500 ppm, or from about 25 to about 1000 ppm, or from about 50 to about 750 ppm, or from about 100 to about 500 ppm, or from about 200 to about 300 ppm, or other amounts, on a solids weight basis.

The present invention includes the following aspects/embodiments/features in any order and/or in any combination:

1. A method for treating water, comprising a) mixing source water, cellulose, and at least one of a coagulant and flocculant, to provide treated water, wherein the water contains suspended solids and the cellulose comprises at least one of microfibrillated cellulose (MFC), nanofibrillated cellulose (NFC), microcrystalline cellulose (MCC), ultrafine cellulose (UFC), or any combination thereof, and b) at least partially separating the solids from the treated water.
2. The method of any preceding or following embodiment/feature/aspect, wherein the microfibrillated cellulose (MFC), nanofibrillated cellulose (NFC), microcrystalline cellulose (MCC), and ultrafine cellulose (UFC) comprises at least 10 wt % by weight of all cellulose used in said method.
3. The method of any preceding or following embodiment/feature/aspect, wherein the microfibrillated cellulose (MFC), nanofibrillated cellulose (NFC), microcrystalline cellulose (MCC), and ultrafine cellulose (UFC) comprises from about 90 to 100 wt % by weight of all cellulose used in said method.
4. The method of any preceding or following embodiment/feature/aspect, wherein the cellulose is anionic.
5. The method of any preceding or following embodiment/feature/aspect, wherein the cellulose is microfibrillated cellulose, nanofibrillated cellulose, or any combinations thereof.
6. The method of any preceding or following embodiment/feature/aspect, wherein the cellulose is added to the water in an amount of from about 1 ppm to about 100 ppm on a weight basis.
7. The method of any preceding or following embodiment/feature/aspect, comprising first adding the cellulose to the water, then adding the coagulant, and then adding the flocculant.
8. The method of any preceding or following embodiment/feature/aspect, wherein turbidity is decreased at least 10% in the treated water after the separating as compared to treated water without the cellulose.
9. The method of any preceding or following embodiment/feature/aspect, wherein color is decreased at least 5% in the treated water after the separating as compared to treated water without the cellulose.
10. The method of any preceding or following embodiment/feature/aspect, wherein the source water is river water, stream water, lake water, pond water, reservoir water, well water, spring water, runoff water, cistern water, desalinated seawater, or any combinations thereof.
11. A method for treating water, comprising:

a) mixing source water and cellulose to provide a first treated water, wherein the water contains suspended solids and the cellulose comprises at least one of microfibrillated cellulose, nanofibrillated cellulose, microcrystalline cellulose, ultrafine cellulose, or any combination thereof;

b) mixing the first treated water with coagulant to provide a coagulated treated water;

c) mixing the coagulated treated water with flocculant to provide a flocculated treated water; and

d) at least partially separating the solids from the flocculated treated water.

12. The method of any preceding or following embodiment/feature/aspect, wherein the microfibrillated cellulose (MFC), nanofibrillated cellulose (NFC), microcrystalline cellulose (MCC), and ultrafine cellulose (UFC) comprises at least 10 wt % by weight of all cellulose used in said method.
13. The method of any preceding or following embodiment/feature/aspect, wherein the microfibrillated cellulose (MFC), nanofibrillated cellulose (NFC), microcrystalline cellulose (MCC), and ultrafine cellulose (UFC) comprises from about 90 to 100 wt % by weight of all cellulose used in said method.
14. The method of any preceding or following embodiment/feature/aspect, wherein the cellulose is anionic.
15. The method of any preceding or following embodiment/feature/aspect, wherein the cellulose is microfibrillated cellulose, nanofibrillated cellulose, or any combinations thereof.
16. The method of any preceding or following embodiment/feature/aspect, wherein the cellulose is added to the water in an amount of from about 1 ppm to about 100 ppm on a weight basis.
17. The method of any preceding or following embodiment/feature/aspect, wherein turbidity is decreased at least 10% in the treated water after the separating as compared to treated water without the cellulose.
18. The method of any preceding or following embodiment/feature/aspect, wherein color is decreased at least 5% in the treated water after the separating as compared to treated water without the cellulose.
19. The method of any preceding or following embodiment/feature/aspect, wherein a dosage of the coagulant used on the water which is treated with the cellulose is reduced by at least 40% compared to a dosage used on water that is unmodified with the cellulose and treated with the coagulant and flocculant, and provide at least the same weight percentage of solids removal from the water.
20. The method of any preceding or following embodiment/feature/aspect, wherein the source water is river water, stream water, lake water, pond water, reservoir water, well water, spring water, runoff water, cistern water, desalinated seawater, or any combinations thereof.
21. The method of any preceding or following embodiment/feature/aspect, wherein steps a), b), and c) are performed sequentially in non-overlapping time periods.
22. The method of any preceding or following embodiment/feature/aspect, wherein the coagulant is a tannin-based ammonium salt, ferric sulfate, ferric chloride, aluminum sulfate (alum), polyaluminum chloride (PAC), sodium aluminate, polyferric sulfate, aluminum chlorohydrate, polyaluminum silicate chloride, epichlorohydrin dimethylamine copolymer (epi-DMA), diallyldimethylammonium chloride (DADMAC), polyamines, melamine formaldehyde resin, polyethylenimine, or any combination thereof.
23. The method of any preceding or following embodiment/feature/aspect, wherein the flocculant is a polyacrylamide polymer, polyethyleneimine, polyimide-amine, polyamine, polyethylene oxide, sulfonated compound, starch derivative, polysaccharide, alginate, activated silica, colloidal clay, alum, ferric hydroxide, or any combination thereof.

The present invention can include any combination of these various features or embodiments above and/or below as set forth in sentences and/or paragraphs. Any combination of disclosed features herein is considered part of the present invention and no limitation is intended with respect to combinable features.

The present invention will be further clarified by the following examples, which are intended to be purely exemplary of the present invention, in which parts are proportions by weight unless otherwise specified.

### EXAMPLES

### Example 1

Water treatment tests were performed to study the effects of modified cellulose on coagulant/flocculation treatments performed on river water.

With respect to the materials used, river water was obtained from the Mississippi River at Mississippi Greenbelt Park on Mud Island in Memphis, Tenn. As coagulants, BUBOND® 408, BUBOND® 505, and BUBOND® 5828, were used. As flocculants, BUFLOC 5904® and BUFLOC® 5532 were used. The modified cellulose was a microfibrillated cellulose (MFC), which was obtained from the University of Maine.

With respect to the method of the studies, a Jar Test was used to combine and process the materials, wherein 1000 ml raw water was loaded into the test jar, and coagulant was added to the water and the combination agitated at 100 rpm for one minute, and then a flocculant was added with mixing continued at 30 rpm for 9 minutes, and finally a settling period (0 rpm) for 10 minutes.

In these tests, MFC dosage was 3 ppm. Flocculant BUFLOC® 5904 dosage was 1 ppm. All other chemicals were used at a dosage of 10 ppm. The stirrer used was a 4-Stirrer Model 7790-100. Turbidity was measured on the filtrate in the jar using a 2100 P Turbidimeter (HACH). Color was measured by DR/870 Colorimeter (HACH, program 19).

Results of the Jar Test are shown in Table 2. In Table 2, the abbreviation “MFC+505+F” refers to a process sequence of first adding MFC, then BUBOND® 505, and finally flocculant. Other combinations indicated in Table 2 using plus symbols (“+”) also indicate the sequence of addition (from right-to-left). The abbreviation “408” refers to BUBOND® 408, and “5828” refers to BUBOND® 5828. There is no data for several entries.

TABLE 2
Effect of MFC on coagulant on water treatment (Turbidity and Color value)

| | Water | | | |
|---|---|---|---|---|
| Chemical | Turbidity (NTU) | (%) | Color | (%) |
| Control | 25 | — | 439 | — |
| 505 + F | 12 | — | 229 | — |
| MFC + 505 + F | 9 | 25 | 177 | 22.71 |
| 505 + MFC + F | 9 | 25 | 166 | 27.51 |
| 505 + F + MFC | 9 | 25 | 150 | 34.50 |
| 408 + F | 12 | — | 255 | — |
| MFC + 408 + F | 10 | 16.67 | 236 | 8.05 |
| 5828 + F | 10 | — | 283 | — |
| MFC + 5828 + F | 9 | 10 | 271 | 4.24 |
| 5828 + MFC + F | 8 | 20 | 249 | 12.01 |
| 5828 + F + MFC | 8 | 20 | 242 | 14.49 |

It can be seen in Table 2 that (a) all three coagulants' efficiency (BUBOND® 408, BUBOND® 505, and BUBOND® 5828) have been improved (i.e., lower turbidity and lower color number) by adding a low dosage MFC (3 ppm); (b) the adding point affects results especially for color value; and (c) the particular coagulant used can affect MFC efficacy as well.

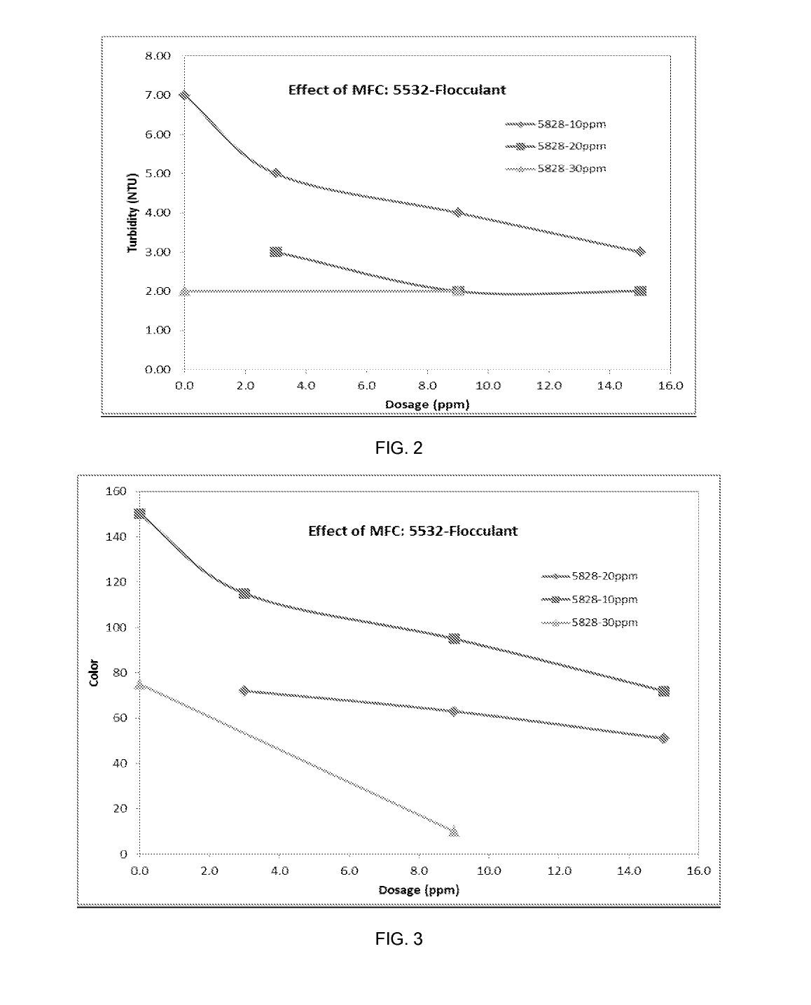

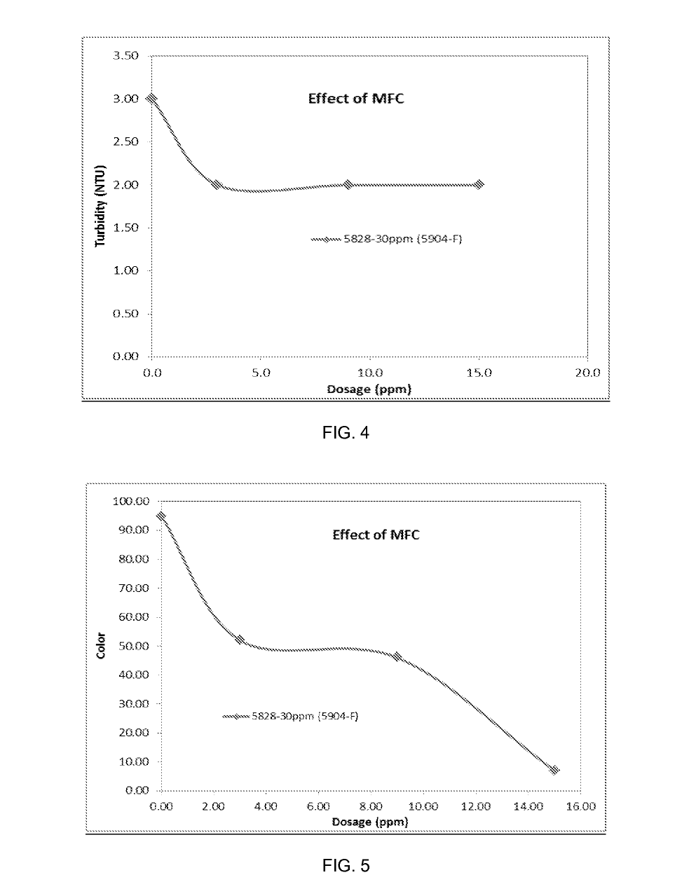

The above tests were repeated for separate river samples using a different flocculant in some of the testing, BUFLOC® 5532, and at various different coagulant and flocculant amounts. Results of these tests are shown in FIGS. 2-5.

FIGS. 2-5 show that (a) MFC does improve BUBOND® 5828 efficiency for removing color, decreasing turbidity, but performance is difference at different dosage of BUBOND® 5828. Such as at low dosage of BUBOND® 5828 of 10 ppm, BUBOND® 5828 efficacy for both turbidity and color are improved by adding MFC, however, at high dosage of BUBOND® 5828, MFC can only improve BUBOND® 5828 efficacy of removing color; and (b) a particular flocculant used can affect MFC efficacy, especially for removing color.

### Example 2

Water treatment tests were performed to study the effects of ultrafine cellulose and microcrystalline cellulose as the modified cellulose on coagulant/flocculation treatments performed on river water.

With respect to the materials used, river water was obtained from the Mississippi River at Mississippi Greenbelt Park on Mud Island in Memphis, Tenn. As coagulant, BUBOND® 5828 was used. As flocculant, BUFLOC® 5532 was used. The modified celluloses used in these tests were ultrafine cellulose (UFC), obtained as ARBOCELL® UFC-100) from JRS, Inc. USA, and microcrystalline cellulose (MCC), obtained as COS 5 from JRS Inc., USA.

With respect to the method of the studies, a Jar Test was used to combine and process the materials, wherein 1000 ml raw water was loaded into the test jar, and coagulant was added to the water and the combination agitated at 100 rpm for one minute, and then flocculant was added with mixing continued at 30 rpm for 9 minutes, and finally a settling period (0 rpm) for 10 minutes.

In these tests, the dosage of ultrafine cellulose (UFC), microcrystalline cellulose (MCC), coagulant BUBOND® 5828, and flocculant BUFLOC® 5532 used is indicated in Tables 3 and 4. The stirrer used was a 4-Stirrer Model 7790-100. Turbidity was measured on the filtrate in the jar using a 2100 P Turbidimeter (HACH). Color was measured by DR/870 Colorimeter (HACH, program 19).

Results of the Jar Tests are shown in Tables 3 and 4. In Tables 3 and 4, the abbreviation “5828” refers to BUBOND® 5828, and “5532” refers to the flocculant BUFLOC® 5532. In Tables 3 and 4, the abbreviation “First” refers to a process sequence of first adding UFC or MCC in the indicated ppm value before adding flocculant. The abbreviation “After 5828” or “After 5532” refers to a process sequence of adding UFC or MCC in the indicated ppm value after adding the indicated coagulant and flocculant. The abbreviation “mixed” in Table 3 refers to adding the UFC as a mixture with the indicated coagulant or flocculant in the respective indicated ppm amounts.

TABLE 3
Effect of UFC on coagulant on water treatment (Turbidity and Color value)

| Run | 5828 (ppm) | UFC (ppm) | 5532 (ppm) | Turbidity (NTU) | Color |
|---|---|---|---|---|---|
| 1 | 0 | 0 | 0 | 24 | 403 |
| 2 | 10 | 0 | 1 | 9 | 197 |
| 3 | 10 | 3-First | 1 | 10 | 180 |
| 4 | 10 | 6-First | 1 | 9 | 176 |
| 5 | 10 | 15-First | 1 | 10 | 206 |
| 4 | 10 | 6-First | 1 | 9 | 176 |
| 6 | 10 | 6-After 5828 | 1 | 9 | 179 |
| 7 | 10 | 6-After 5532 | 1 | 11 | 214 |

| | | | | |
|---|---|---|---|---|
| 8 | Mixed (10 ppm-5828 and 6 ppm- | 1 | 12 | 244 |
| | UFC) | | | |

| | | | | |
|---|---|---|---|---|
| 9 | 10 | Mixed (6 ppm-UFC and 1 ppm- | 10 | 202 |
| | | 5532) | | |

The test results in Table 3 show that (a) UFC-100 (adding 6 ppm) can improve the coagulant (BUBOND® 5828) efficiency for removing color (˜10%), with turbidity maintained at reduced levels, and there can be an optimal dosage, such as 6 ppm-UFC for 10 ppm-coagulant BUBOND® 5828 dosage for the improvements; (b) UFC should be added before a flocculant, but cannot be mixed with a coagulant or a flocculant for positive results.

TABLE 4
Effect of MCC on coagulant on water treatment
(Turbidity and Color value)

| | 5828 | MCC | 5532 | Turbidity | |
|---|---|---|---|---|---|
| Run | (ppm) | (ppm) | (ppm) | (NTU) | Color |
| 1 | 0 | 0 | 0 | 24 | 403 |
| 2 | 10 | 0 | 1 | 9 | 197 |
| 10 | 50 | 0 | 1 | 3 | 59 |
| 11 | 50 | 0 | 1 | 3 | 59 |
| 12 | 50 | 0.75-First | 1 | 3 | 59 |
| 13 | 50 | 1.5-First | 1 | 2 | 64 |
| 14 | 50 | 3-First | 1 | 2 | 58 |
| 15 | 50 | 1.5 After 5828 | 1 | 2 | 59 |
| 16 | 50 | 1.5 After 5532 | 1 | 3 | 76 |

The test results in Table 4 show that adding a small amount of MCC (1.5-3 ppm) improves coagulant (BUBOND® 5828) (dosage 50 ppm) efficiency for turbidity (3 to 2: 33%), with color maintained at reduced levels, and that MCC should be added before a flocculant to get positive results.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method for treating water, comprising a) mixing source water, cellulose, and at least one coagulant, or at least one flocculant or both, to provide treated water, wherein the treated water contains suspended solids, and wherein the cellulose comprises microfibrillated cellulose (MFC), nanofibrillated cellulose (NFC), microcrystalline cellulose (MCC), or ultrafine cellulose (UFC), or any combination thereof, and b) at least partially separating the solids from the treated water.

2. The method of claim 1, wherein the microfibrillated cellulose (MFC), nanofibrillated cellulose (NFC), microcrystalline cellulose (MCC), and ultrafine cellulose (UFC) comprises at least 10 wt % by weight of all cellulose used in said method.

3. The method of claim 1, wherein the microfibrillated cellulose (MFC), nanofibrillated cellulose (NFC), microcrystalline cellulose (MCC), and ultrafine cellulose (UFC) comprises from about 90 to 100 wt % by weight of all cellulose used in said method.

4. The method of claim 1, wherein the cellulose is anionic.

5. The method of claim 1, wherein the cellulose is microfibrillated cellulose, nanofibrillated cellulose, or any combinations thereof.

6. The method of claim 1, wherein the cellulose is added to the water in an amount of from about 1 ppm to about 100 ppm on a weight basis.

7. The method of claim 1, comprising first adding the cellulose to the water, then adding the coagulant, and then adding the flocculant.

8. The method of claim 1, wherein turbidity is decreased at least 10% in the treated water after the separating as compared to treated water without the cellulose.

9. The method of claim 1, wherein color is decreased at least 5% in the treated water after the separating as compared to treated water without the cellulose.

10. The method of claim 1, wherein the source water is river water, stream water, lake water, pond water, reservoir water, well water, spring water, runoff water, cistern water, desalinated seawater, or any combinations thereof.

11. A method for treating water, comprising:
a) mixing source water and cellulose to provide a first treated water, wherein the first treated water contains suspended solids and the cellulose comprises microfibrillated cellulose, nanofibrillated cellulose, microcrystalline cellulose, or ultrafine cellulose, or any combination thereof;
b) mixing the first treated water with coagulant to provide a coagulated treated water;
c) mixing the coagulated treated water with flocculant to provide a flocculated treated water; and
d) at least partially separating the solids from the flocculated treated water.

12. The method of claim 11, wherein the microfibrillated cellulose (MFC), nanofibrillated cellulose (NFC), microcrystalline cellulose (MCC), and ultrafine cellulose (UFC) comprises at least 10 wt % by weight of all cellulose used in said method.

13. The method of claim 11, wherein the microfibrillated cellulose (MFC), nanofibrillated cellulose (NFC), microcrystalline cellulose (MCC), and ultrafine cellulose (UFC) comprises from about 90 to 100 wt % by weight of all cellulose used in said method.

14. The method of claim 11, wherein the cellulose is anionic.

15. The method of claim 11, wherein the cellulose is microfibrillated cellulose, nanofibrillated cellulose, or any combinations thereof.

16. The method of claim 11, wherein the cellulose is added to the water in an amount of from about 1 ppm to about 100 ppm on a weight basis.

17. The method of claim 11, wherein turbidity is decreased at least 10% in the treated water after the separating as compared to treated water without the cellulose.

18. The method of claim 11, wherein color is decreased at least 5% in the treated water after the separating as compared to treated water without the cellulose.

19. The method of claim 11, wherein a dosage of the coagulant used on the water which is treated with the cellulose is reduced by at least 40% compared to a dosage used on water that is unmodified with the cellulose and treated with the coagulant and flocculant, and provide at least the same weight percentage of solids removal from the water.

20. The method of claim 11, wherein the source water is river water, stream water, lake water, pond water, reservoir water, well water, spring water, runoff water, cistern water, desalinated seawater, or any combinations thereof.

21. The method of claim 11, wherein steps a), b), and c) are performed sequentially in non-overlapping time periods.

22. The method of claim 11, wherein the coagulant is a tannin-based ammonium salt, ferric sulfate, ferric chloride, aluminum sulfate (alum), polyaluminum chloride (PAC), sodium aluminate, polyferric sulfate, aluminum chlorohydrate, polyaluminum silicate chloride, epichlorohydrin dimethylamine copolymer (epi-DMA), diallyldimethylammonium chloride (DADMAC), polyamines, melamine formaldehyde resin, polyethylenimine, or any combination thereof.

23. The method of claim 11, wherein the flocculant is a polyacrylamide polymer, polyethyleneimine, polyamide-amine, polyamine, polyethylene oxide, sulfonated compound, starch derivative, polysaccharide, alginate, activated silica, colloidal clay, alum, ferric hydroxide, or any combination thereof.
